(19) United States
(12) Patent Application Publication
(10) Pub. No.: US 2009/0222890 A1
(43) Pub. Date: Sep. 3, 2009

(54) METHOD AND APPARATUS FOR PROVIDING STREAMING SERVICE BASED ON P2P AND STREAMING SERVICE SYSTEM USING THE SAME

(75) Inventors: Sung-Joo Kang, Seoul (KR); Kyong-I Ku, Kyungki-do (KR); Sung-Jin Hur, Daejeon (KR); Wan Choi, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/096,735

(22) PCT Filed: Nov. 29, 2006
(86) PCT No.: PCT/KR2006/005110

§ 371 Date: Sep. 3, 2008

(30) Foreign Application Priority Data
Dec. 7, 2005 (KR) 10-2005-0119128

(51) Int. Cl. G06F 15/16; G06F 21/00

(52) U.S. Cl. 726/3; 709/231

(57) ABSTRACT

A method and apparatus for providing a stream service based on P2P and a streaming service system using the same are provided. In order to provide the stream service to peers without concentrating the load thereof to a server, the each peer includes an apparatus for providing a streaming service. The streaming service apparatus includes a peer communication module, a storing unit, and a peer server unit and a peer client unit. By using a streamable software list and a peer list transmitted from the peer communication module, the peer server unit for receiving a streaming service request from other peers, reading corresponding software from the storing unit and providing a streaming service for the read software. Also, the peer client unit requests a streaming service for predetermined software to other peer, and stores streamable software, which is received from other peers through the streaming service, in the storing unit.

### TECHNICAL FIELD

The present invention relates to a method and apparatus for providing a streaming service based on the peer-to-peer (P2P) and a streaming service system using the same for reducing the load of a server by allowing a peer to provide streaming service to other peer through the peer-to-peer (P2P) network.

### BACKGROUND ART

Streaming is a media consuming scheme for playing audio, video or animation on the Internet in real-time. Since a streaming system sequentially playing received data at the receiver while receiving next data, a delay time is shortened and it is not restricted by the storing unit capacity of the receiving end. Therefore, the streaming becomes the essential technology for Internet broadcasting programs.

The software to provide through the streaming scheme is repackaged through additional procedures in order to instantly execute the software at the receiving end.

FIG. 1 is a block diagram illustrating the basic structure of software to be delivered through the streaming. The streamable software includes an initial execution file and page 100 for performing initial operations until displaying a graphic user interface of application program and waiting an input from a user, and an execution page 110 for performing corresponding operations and functions in response to a user's input.

The initial execution file and page 100 is initial data transmitted when a client requests a streaming service. That is, the initial execution file and page 100 is a page required for performing the initial operations until performing a step of waiting a user's input after executing a meta file and an application program for corresponding software.

The execution page 110 is a page for performing operations and functions requested by a user after performing the initial operation of the application program based on the initial execution file and page 100.

The streamable software having the structure shown in FIG. 1 is stored in a streaming server. The streaming server transmits the stored streamable software to a corresponding client according to the request of the client.

FIG. 2 is a flowchart of a method of providing a streaming service between a client and a streaming server according to the related art.

Referring to FIG. 2, when a client 200 requests a streaming service to a streaming server 210 at step S220, the streaming server 210 transmits an initial execution file and page 211 among the initial execution file and page 211 and an execution page 212 of streamable software to the client 200 at step S221. Then, the client 200 stores the initial execution file and page 211 and executes the application program of corresponding software.

After completely performing the initial operation as described above, the client 200 requests the streaming server 210 to transmit the execution page for performing corresponding operations according to predetermined functions and operations requested by a user at step S230. The streaming server 210 transmits the requested execution page to the client 200. Herein, the exact part of the execution page is requested and transmitted according to the requested functions and operations.

The steps S230 and S231 are repeatedly performed according to the user s request. The more the functions in the application program are used by a user, the more the execution pages are stored in the client 200. If the user uses all the functions and operations of the application program, entire of the initial execution file and page and the execution page of the corresponding software will be stored in the client 200.

If the user terminates the corresponding software, the client 200 transmits a service termination request to the streaming server 210 at step S240, and the streaming server 210 transmits a service termination to the client 200 at step S241.

As described above, since the streaming service is provided from the central streaming server to a plurality of the scattered clients according to the conventional streaming service method, the streaming server generally suffers for burden load to provide the streaming service. Also, the streaming server may become disabled for providing the appropriate quality of service to clients if more than acceptable clients request a service at the same time.

### DISCLOSURE OF INVENTION

### Technical Problem

Accordingly, the present invention is directed to a method and apparatus for providing a streaming service based on the P2P, and a streaming server system using the same that substantially obviates one or more problems due to limitations and disadvantages of the related art.

An object of the present invention is to provide a method and apparatus for providing a streaming service based on the peer-to-peer (P2P) and a streaming service system using the same for enabling each peer to provide streamable software to other peers within the permitting range of a license.

Additional advantages, objects, and features of the invention will be set fourth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### Technical Solution

To achieve these objects and other advantages and in accordance with the purpose of the invention, as embodied and broadly described herein, an apparatus for providing a streaming service, including: a peer communication module for transmitting and receiving a streamable software list, which is a list of streamable software, and a peer list, which is the list of peers having predetermined streamable software, through communicating with other peers or a streaming server; a storing unit for storing streamable software; a peer server unit for receiving a streaming service request from other peers, reading corresponding software from the storing unit and providing a streaming service for the read software; and a peer client unit for requesting a streaming service for predetermined software to other peer, and storing streamable software, which is received from other peers through the streaming service, in the storing unit.

The peer communication unit may include: a P2P (peer-to-peer) communication module for receiving and transmitting a streamable software list, which is a list of streamable software, and a peer list, which is a list of peers having predetermined streamable software, through communicating with other peers or a streaming server; a software managing module for managing the streamable software stored in the storing unit, and providing the streamable software list to the P2P communication module; and a license managing module for setting information about a right to use the streamable software stored in the storing unit and the streaming service thereof.

According to an aspect of the present invention, there is provided a method for providing a streaming service based on P2P for a server, including the steps of: a) managing a peer list, which is a list of peers having corresponding software, by software through regularly or occasionally collecting information about software included in each peer; b) receiving a request of a peer list of a predetermined software from a peer; c) verifying the right of the requesting peer to use the predetermined software and the corresponding streaming service; and d) transmitting the peer list to the corresponding peer if the requesting peer has the right.

According to another aspect of the present invention, there is provided a method of providing a streaming service based on P2P including the steps of: a) requesting a peer list, which is a list of peers having corresponding software, to a server if a user selects software to receive a streaming service; b) selecting one of peers in a received peer list of the corresponding software; c) determining whether the selected peer has the corresponding software or not; d) selecting other peer from the received peer list and repeatedly performing the step c) if the selected peer dose not have the corresponding software; and e) requesting the streaming service to the selected peer after determining the selected peer has the corresponding software and receiving the streaming service from the selected peer.

According to still another aspect of the present invention, there is provided a streaming service system for providing a streaming service based on P2P (peer-to-peer), including: a server for managing a peer list, which is a list of peers having corresponding service, by software to provide through a streaming service, and information about an amount of execution file stored in each peer, and providing the peer list with corresponding information to a peer requesting the list; and a plurality of peers each for receiving a streaming service through communicating with other peers included in the peer list through P2P communication and providing own software to other peers through the streaming service.

### ADVANTAGEOUS EFFECTS

As described above, the method and apparatus for providing a streaming service according to the present invention effectively provides a service through distributing the load of the server by enabling each peer to provide streamable software, which is received from a streaming server through the streaming service, to other peers within the permitting range of a license.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating the basic structure of software to be delivered through the streaming;

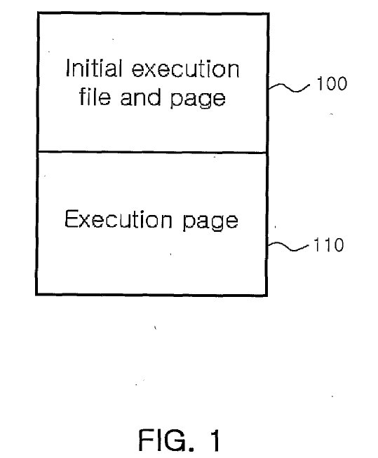

FIG. 2 is a flowchart of a method of providing a streaming service between a client and a streaming server according to the related art;

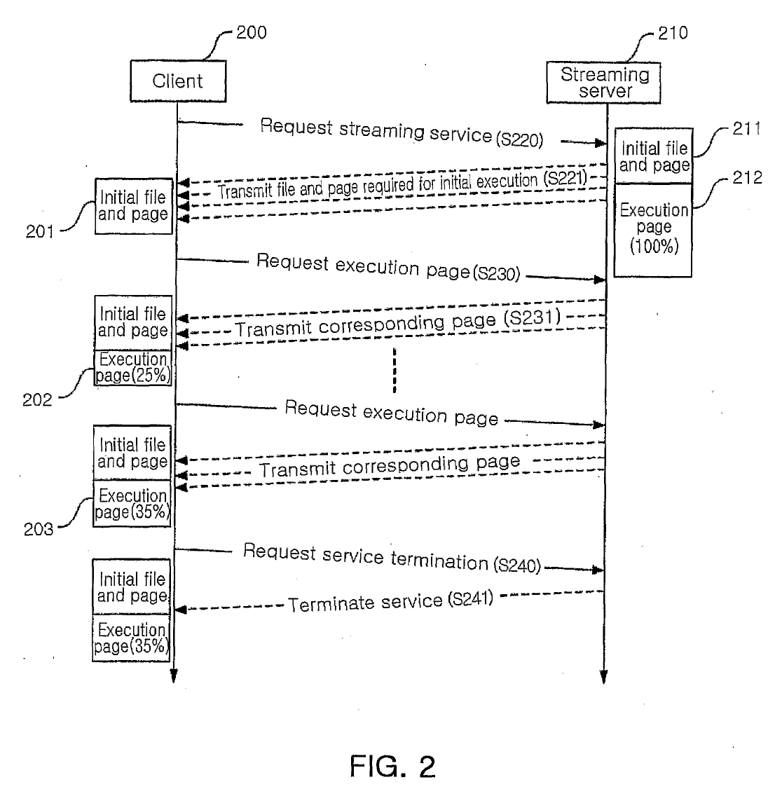

FIG. 3 is a view describing receiving of a streaming service at a client from a streaming server according to an embodiment of the present invention;

FIG. 4 is a block diagram illustrating an apparatus for providing a streaming service according to an embodiment of the present invention;

FIG. 5 is a view showing a streaming service system providing a streaming service according to an embodiment of the present invention; and

FIG. 6 is a flowchart of a method for providing a streaming service according to an embodiment of the present invention.

### BEST MODE FOR CARRYING OUT THE INVENTION

Reference will now be made in detail to the preferred embodiments of the present invention, examples of which are illustrated in the accompanying drawings.

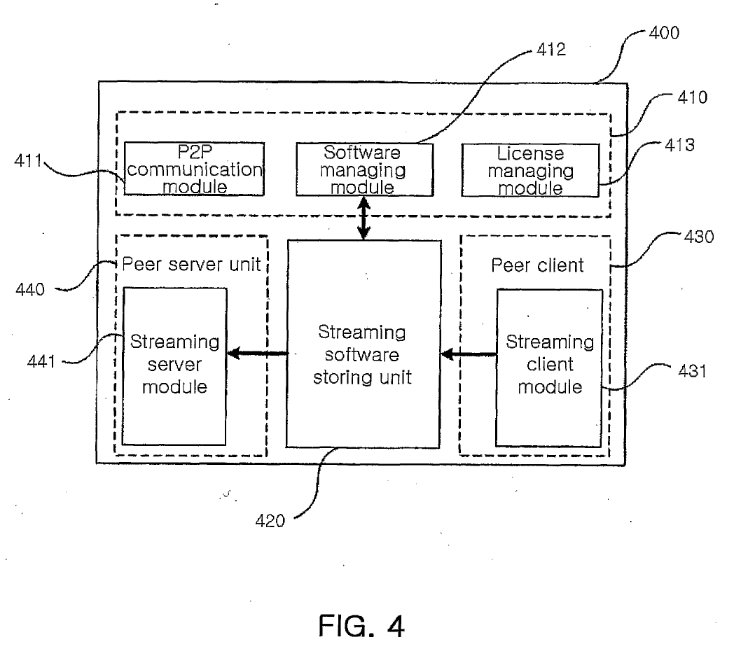

FIG. 4 is a block diagram illustrating an apparatus for providing a streaming service according to an embodiment of the present invention.

Referring FIG. 4, the streaming service providing apparatus according to the present embodiment includes a peer communication module 410, a storing unit 420, a peer client unit 430, and a peer server unit 440.

The peer communication module 410 includes a P2P communication module 411 for transmitting and receiving a list of streamable software to/from other peers, and receiving a list of peers having software and transmitting own software information through communicating with the streaming server which is a P2P central server, a software managing module 412 for managing a list of streamable software stored in the storing unit 420 and providing a streaming software list to the P2P communication module 311, and a license managing module 413 for setting the streaming service right for a streamable software stored in the storing unit 420. The streaming service right of each peer is set in the license managing module 413, and the streaming service right is certified by the central streaming server.

The storing unit 420 stores streamable software received through the peer client unit 430. As described above, the storing unit 420 stores the streamable software by dividing the streamable software into an initial execution file and page and an execution page.

The peer client unit 430 includes a streaming client module 431 for requesting a streaming service to a user selected peer.

The peer server unit 440 includes a streaming server module 441 for performing a streaming service to a corresponding peer in response to a streaming service request from other peers.

The streaming service providing apparatus according to the present embodiment is included in each peer. Each of the peers may be a user terminal for using the streaming service, or a system for providing the streaming service. The streaming service providing apparatus according to the present embodiment enables the streamable software stored in each user terminal to be shared so as to distribute the load of the central server. Herein, the streamable software may be software that is transferred from a streaming server and stored for receiving a predetermined service, or may be software stored in a peer only. In the case of streamable software stored in a predetermined peer only, other peers can receive the streaming service stored in the predetermined peer by accessing the predetermined peer after registering the predetermined peer to the central streaming server.

In the case of the streamable software which is transferred from the streaming server and stored in peers for receiving a predetermined service, the amount of the streamable software stored in peers becomes varied according to the amount of using the corresponding software by a user.

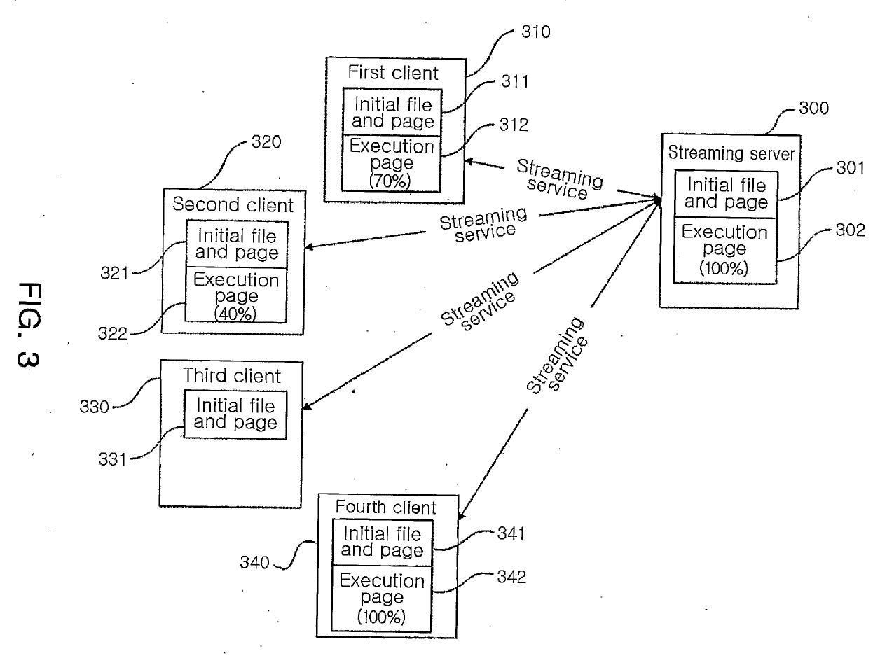

FIG. 3 is a view describing receiving of a streaming service at a client from a streaming server according to an embodiment of the present invention.

Generally, a streaming server 300 includes entire of an initial execution page 301 and an execution page 302 for streamable software. If first to fourth clients 310 to 340 request streaming services to the streaming server 300 and receive the corresponding streams from the streaming server 300, the streaming server 300 transmits the initial execution file and page 301 to the first to fourth clients 310 to 340 because the initial execution file and page 301 is data transferred at a service initialization stage.

Therefore, the first to fourth clients 310 to 340 commonly have the initial execution file and page 301. However, the predetermined part of the execution page is transferred to the clients according to requested function and operation in corresponding software.

Therefore, the amount of the execution page in the first to fourth client differs according to the amount of using the corresponding software.

As shown in FIG. 3, the first client 310 includes the initial execution file and page 311 and 70% of the execution file 312. The second client 320 includes the initial execution file and page 311 and the 40% of execution file 312. After the initial operation, the third client 330 includes the initial execution file and page 331 only. The fourth client 340 which uses all of the functions of corresponding software includes the initial execution file and page and 100% of the execution page 341.

As described above, the amount of streamable software in clients may differ according to the amount of using the corresponding software. In the method and apparatus for providing the streaming service according to the present embodiment, the streaming server provides not only the list of peers having corresponding streamable software but also the information about software stored in each peer in order to allow a user side to select one of the peers in order to receive a predetermined streaming service.

### MODE FOR THE INVENTION

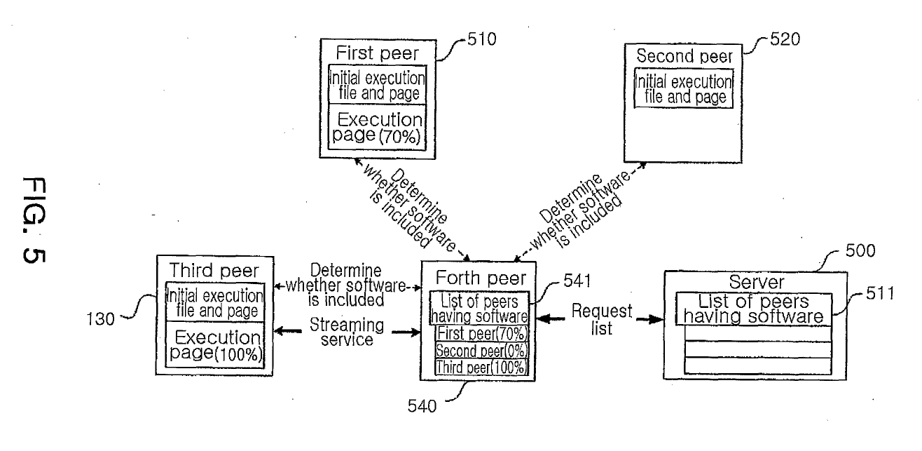

FIG. 5 is a view showing a streaming service system providing a streaming service according to an embodiment of the present invention.

Referring to FIG. 5, the streaming service system according to the present embodiment includes a server 500 for managing peer information about peers having predetermined software and an amount of execution page stored in each peer, and first to fourth peers 510 to 540 each having the streaming service providing apparatus shown in FIG. 4 for providing and receiving a streaming service through P2P communication.

As shown in FIG. 5, the first peer 510, the second peer 520 and the third peer 530 have an initial execution file and page. The first peer 510 includes 70% of execution page, and the third peer 530 includes 100% of execution page. Such peer information about software included in each peer and the amount of execution page in each peer are managed in the server 500.

When the fourth peer 540 requests corresponding software to the server 500, the fourth peer 540 requests a list of peers having corresponding software to the server 500. Then, the server 500 transfers the peer list and the amount of execution page stored in each peer to the fourth peer 540. The fourth peer 540 selects one of the peers in the peer list and requests the streaming service to the selected peer through the streaming client module 431. It is preferable that the fourth peer 541 may select one having largest amount of execution page among the peers in the list and requests the streaming service to the selected peer.

For example, if the fourth peer 541 selects the third peer 530 and requests the predetermined streaming service, the streaming server module 441 of the third peer 530 provides the streaming service to the fourth peer 540 by transmitting the initial execution file and the execution page to the fourth peer 540.

As described above, the load of the streaming service is distributed through all of peers. Therefore, the load for providing the streaming service of the server 500 is reduced according to the present embodiment.

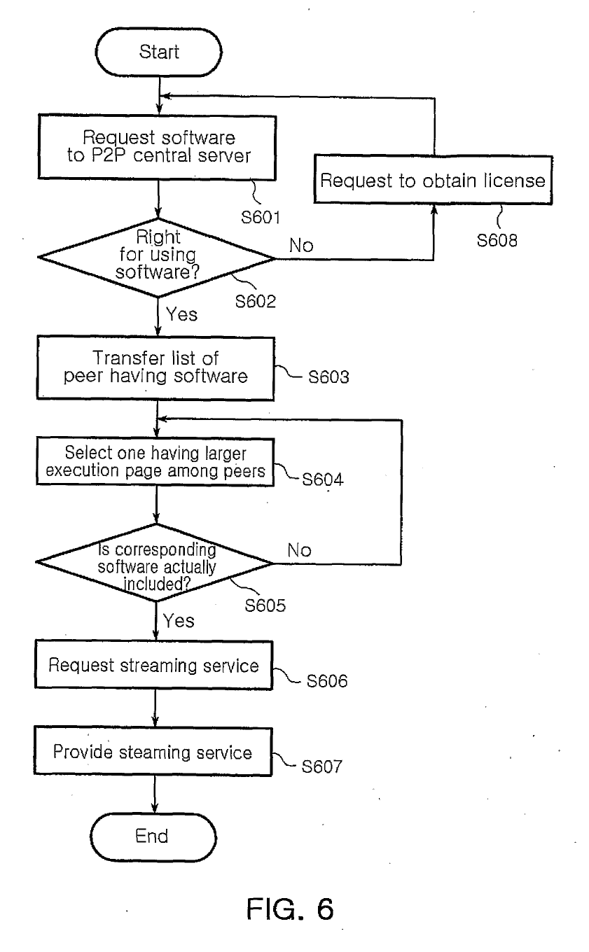

FIG. 6 is a flowchart of a method for providing a streaming service according to an embodiment of the present invention. Hereinafter, the streaming service providing method will be described in detail with reference to FIG. 6.

Referring to FIG. 6, if a user selects software through a user peer having a streaming service providing apparatus according to the present embodiment, the user peer requests the server to search peers having corresponding software at step S601.

Then, the server determines whether the user peer has a license to use the requested software or not at step S602. If the peer does not have the license, the server requests the peer to obtain the license at step S608. Herein, the identification of the license managing module 413 of the user peer may be inquired to determine whether the user peer has the license to use the requested software.

The server transfers the peer list, which is a list of peers having the corresponding software, to the user peer having the license at step S603. Then, the user peer selects one of peers in the peer list at step S604. The peer for receiving the streaming service may be selected by user s subjective determination. It is preferable that one having the largest execution page may be selected from the peers in the peer list.

After selecting the peer, it determines whether the selected peer has the corresponding software or not at step S605. If the selected peer does not have the corresponding software, other peer is selected.

If the selected peer has the corresponding software, the streaming client module 431 of the user peer requests the streaming service to the streaming server module 441 of the selected peer at step S606. Then, the streaming server module 441 of the selected peer provides the streaming service of the corresponding software to the user peer at step S607.

### INDUSTRIAL APPLICABILITY

As described above, the streaming service providing method and apparatus according to the present invention allows peers to provide streamable software to other peers by reusing the streamable software stored the peers. Therefore, the load of the streaming service can be reduced, and the peer can receive the optimized service without regarding to the network state by selecting a service provider from the streaming server and the peers.

Furthermore, the peers are allowed to receive a streaming service of predetermined software through accessing a system that originally owns the predetermined software by simply registering the system to a streaming server.

It will be apparent to those skilled in the art that various modifications and variations can be made in the present invention. Thus, it is intended that the present invention covers the modifications and variations of this invention provided they come within the scope of the appended claims and their equivalents.

1. An apparatus for providing a streaming service, comprising:
a peer communication module for transmitting and receiving a streamable software list, which is a list of streamable software, and a peer list, which is a list of peers having predetermined streamable software, through communicating with other peers or a streaming server;
a storing unit for storing streamable software;
a peer server unit for receiving a streaming service request from other peers, reading corresponding software from the storing unit and providing a streaming service for the read software; and
a peer client unit for requesting a streaming service for predetermined software to other peer, and storing streamable software, which is received from other peers through the streaming service, in the storing unit.

2. The apparatus of claim 1, wherein the peer communication unit includes:
a P2P (peer-to-peer) communication module for receiving and transmitting a streamable software list, which is a list of streamable software, and a peer list, which is a list of peers having predetermined streamable software, through communicating with other peers or a streaming server;
a software managing module for managing the streamable software stored in the storing unit, and providing the streamable software list to the P2P communication module; and
a license managing module for setting information about a right to use the streamable software stored in the storing unit and the streaming service thereof.

3. A method for providing a streaming service based on P2P for a server, comprising the steps of:
a) managing a peer list, which is a list of peers having corresponding software, by software through regularly or occasionally collecting information about software included in each peer;
b) receiving a request of a peer list of a predetermined software from a peer;
c) verifying a right of the requesting peer to use the predetermined software and the corresponding streaming service; and
d) transmitting the peer list to the corresponding peer if the requesting peer has the right.

4. The method of claim 3, wherein the server manages the peer list by software with information about the amount of execution page stored in each peer.

5. A method of providing a streaming service based on P2P comprising the steps of:
a) requesting a peer list, which is a list of peers having corresponding software, to a server if a user selects software to receive a streaming service;
b) selecting one of peers in a received peer list of the corresponding software;
c) determining whether the selected peer has the corresponding software or not;
d) selecting other peer from the received peer list and repeatedly performing the step c) if the selected peer dose not have the corresponding software; and
e) requesting the streaming service to the selected peer after determining the selected peer has the corresponding software and receiving the streaming service from the selected peer.

6. A streaming service system for providing a streaming service based on P2P (peer-to-peer), comprising:
a server for managing a peer list, which is a list of peers having corresponding service, by software to provide through a streaming service, and information about an amount of execution file stored in each peer, and providing the peer list with corresponding information to a peer requesting the list; and
a plurality of peers each for receiving a streaming service through communicating with other peers included in the peer list through P2P communication and providing own software to other peers through the streaming service.

7. The streaming service system of claim 6, wherein the peer includes:
a peer communication module for transmitting and receiving a streamable software list, which is a list of streamable software, and a peer list, which is a list of peers having predetermined streamable software, through communicating with other peers or a streaming server;
a storing unit for storing streamable software;
a peer server unit for receiving a streaming service request from other peers, reading corresponding software from the storing unit and providing a streaming service for the read software; and
a peer client unit for requesting a streaming service for predetermined software to other peer, and storing streamable software, which is received from other peers through the streaming service, in the storing unit.

8. The streaming service system of claim 7, wherein the peer communication unit includes:
a P2P (peer-to-peer) communication module for receiving and transmitting a streamable software list, which is a list of streamable software, and a peer list, which is a list of peers having predetermined streamable software, through communicating with other peers or a streaming server;
a software managing module for managing the streamable software stored in the storing unit, and providing the streamable software list to the P2P communication module; and
a license managing module for setting information about a right to use the streamable software stored in the storing unit and the streaming service thereof.
